(19) United States
(12) Patent Application Publication
(10) Pub. No.: US 2004/0208239 A1
(43) Pub. Date: Oct. 21, 2004

(54) Method and apparatus for the intelligent and automatic gathering of sudden short duration communications signals

(76) Inventor: Lars Karlsson, Santa Clara, CA (US)

Correspondence Address: Karl M. Steins, Steins & Associates, Suite 120, 2333 Camino del Rio South, San Diego, CA, 92108, US

(21) Appl. No.: 10/829,858

(22) Filed: Apr. 21, 2004

Related U.S. Application Data
(60) Provisional application No. 60/464,016, filed on Apr. 21, 2003.

(51) Int. Cl. H04B 1/38

(52) U.S. Cl. 375/219

(57) ABSTRACT

A Method and Apparatus for the Intelligent and Automatic Gathering of Sudden Short Duration Communications Signals is disclosed. Also disclosed is a method that automatically detects, captures, and intelligently evaluates sudden, short duration communications signals. The system has the ability to automatically detect short duration signals and then automatically make a determination if a received signal is a new signal. The system then can provide alerts and automatic resolution focusing of new signals as soon as these short duration signals are detected. And finally, the system provides interactive and intelligent spectrum displays.

In an alternate embodiment the system and method automatically demodulates, stores, and processes the signals. In yet another alternative embodiment, the system can be remotely controlled over a network and collect the same information from similar systems.

This application is filed within one year of, and claims priority to Provisional Application Serial No. 60/464,016, filed Apr. 21, 2003.

### BACKGROUND OF THE INVENTION

1. Field of the Invention

This invention relates generally to signal intelligence systems and, more specifically, to a Method and Apparatus for the Intelligent and Automatic Gathering of Sudden Short Duration Communications Signals.

2. Description of Related Art

Signal Intelligence (“SIGINT”) Operations today typically involves a radio operator (or several operators) using various communications receiver equipment to intercept and process clandestine radio frequency (RF) signals. These systems are quite sensitive and can pick up the communications signals from varieties of sources within range. In today's systems, monitoring of those captured signals still requires manual intervention by a radio operator, or an analyst, to determine if the received signals are indeed new signals of interest. Note: In this document, “new signals” are defined as sudden signals (possibly communications signals) that have not been seen by the SIGINT system before. They are not simply one of many known and uninteresting signals that regularly appear, disappear, and then reappear in the radio operator's RF environment. Once a radio operator detects a signal and determines it is a new signal, then a variety of steps (demodulation, decoding, storage, etc.) can be taken to extract certain intelligence from the available captured data.

In order to detect signals as they appear, two main schemes are used today. The first involves a fast scanning “sweeping” receiver that samples the RF spectrum from one frequency to the next and then stops on any signal present having a signal strength that is above a pre-determined threshold. Then it is up to the radio operator to evaluate the signal. Otherwise the operator will command the scanning receiver to continue sweeping. This scheme has drawbacks (as will be described in more detail later) in that the scanning receiver can miss sudden, short-duration signals. In addition, only one signal at a time can be manually evaluated.

To answer the problem of being able to evaluate multiple signals at a time, a more advanced setup is used today. This involves using a scanning receiver which then captures a signal and “hands-off” the signal to a fixed “set-on” receiver (through a computer or other device). Once the hand-off is achieved, the scanning receiver can continue to sweep through the RF spectrum looking for additional new signals, while the set-on receiver monitors the recently captured signal. Adding more and more set-on receivers into the system can scale up this process. Thus, the number of simultaneous signals that can be evaluated at a time is equal to the number of set-on receivers in the system. This, though, also requires more radio operators to evaluate the signals. An advantage of this setup is that the set-on receivers have better resolution, and more sensitivity than the scanning receivers. Thus, if a signal is evaluated to be a new signal of interest, the set-on receivers can perform a more precise analysis. Still, this “improved” setup nonetheless has the same drawback as the old SIGINT system, in that the scanning receiver can miss sudden, short-duration signals.

When communications speeds are comparatively slow (e.g. traditional transmissions such as Morse code or voice transmission), the duration of the message is relatively long, varying from several seconds to minutes. Such lengthy communication is relatively easy to detect and intercept with the aforementioned systems.

But modern communication systems though introduce a new challenge—short, burst type transmissions (such as “frequency hoppers”). It is now technically possible to compress a significant amount of information into a small digital package, and to transmit such a package in a very short period of time. For example, a standard commercial 802.11 wireless network can transmit from 2 to 10 megabits per second. One second of speech can be compressed to 10 kilobits. Therefore, if an 802.11 network is used, one second of voice communications can be compressed from 100 to 1000 times, and it will require only 1 to 10 milliseconds to be fully transmitted. There are many other technologies, civilian and military, that utilize high-speed radio transmissions. We will not list all of them here. But it is apparent that more and more transmission systems are upgrading from traditional low speed, lengthy emission schemes to more advanced high speed, short data-burst emission schemes.

As mentioned, this creates a problem for traditional scanning receiver systems since they cannot reliably detect, and therefore cannot analyze, such modern RF transmission technologies. Scanning technology cannot deal with fast signals. And even if a fast signal is detected, it still requires (at some point) a manual decision regarding whether or not this newly captured signal is indeed a new signal of some importance. Often times, captured signals are simply one of many known and uninteresting signals present in the operator's RF environment. Manual decisions on short duration signals is simply not feasible since the decision must be made in a matter of milliseconds. This means that a fundamental change in detection technology is required.

What is needed therefore in order to feasibly monitor these modern transmissions is a reception system that has: 1) The ability to capture wide bandwidth regions of the RF spectrum instantaneously; 2) The ability to automatically discover sudden, short duration signals as they appear; 3) The ability to automatically determine if the signal is a new signal, not seen before by the radio operator; and 4) The ability to automatically increase monitoring resolution and record those short duration signals of interest for further processing and analysis.

The apparatus of this invention provides such a System. In conclusion, no invention formerly developed provides this unique method to automatically detect and capture sudden, short duration signals.

### SUMMARY OF THE INVENTION

In light of the aforementioned problems associated with the prior systems and methods, it is an object of the present invention to provide a Method and Apparatus for the Intelligent and Automatic Gathering of Sudden Short Duration Communications Signals.

Today, a signal intelligence operation involves a radio operator to capture and then manually determine the nature of new signals. Sometimes the operator uses a fast scanning receiver only to detect these new signals. Sometimes the operator uses a fast scanning receiver which then “hands-off” detected signals to more sensitive set-on receivers. But in both cases, this still requires, at some point, a manual decision on whether or not a newly captured signal is indeed a signal of some importance. Often times, newly captured signals are simply one of many known and uninteresting signals present in the operator's RF environment. To make matters worse, modern transmission systems utilize short duration, burst type emissions, which are virtually impossible to intercept manually.

In particular, the operator must manually evaluate if a signal is new and interesting (which again is impossible with sudden, short duration signals), manually use the demodulators of the receiver until the proper output is achieved, and then manually record the data. This is a highly inefficient system and it is costly to train the operator to perform these operations.

In light of these issues associated with prior systems and methods, it is an object of the present invention to provide a method to automatically detect, capture, and intelligently evaluate sudden, short duration communications signals.

The preferred system should first have the ability to automatically detect short duration signals. Secondly the preferred system should be able to automatically make a determination if a received signal is a new signal. Thirdly, the preferred system should then provide alerts and automatic resolution focusing of new signals as soon as these short duration signals are detected. And finally, the preferred system should provide interactive and intelligent spectrum displays.

An alternate embodiment of the invention would be for the invention to automatically demodulate, store, and process the signals.

It is still further an alternative embodiment that the present invention can be remotely controlled over a network and collect the same information from similar systems. The invention can be outfitted with the proper network connectivity hardware (such as Ethernet) and software. Thus in this way, a far more efficient signal intelligence gathering system can be achieved in which multiple surveillance positions can be monitored more efficiently from a centralized command facility.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a prior-art drawing of a present-day scanning receiver system;

FIG. 2 is a prior-art drawing of a more elaborate present-day signal capture system;

FIG. 3 is a functional depiction of a preferred embodiment of the system of the present invention;

FIG. 4 is a flowchart depicting the operational method of the system of FIG. 1;

FIG. 5 is a flowchart depicting the operational method of the system of FIG. 2; and

FIG. 6 is a flowchart depicting the operational method of the system of FIG. 3.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Method and Apparatus for the Intelligent and Automatic Gathering of Sudden Short Duration Communications Signals.

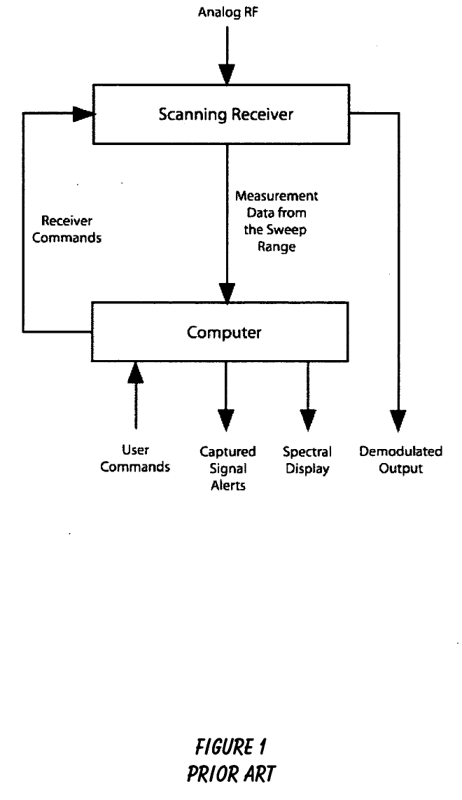

The present invention can best be understood by initial consideration of FIG. 1. The prior-art of FIG. 1 is a present-day scanning receiver system. The receiver quickly sweeps through the RF spectrum and stops on acquired signals that exceed a pre-determined threshold strength and duration. A modern scanning receiver can sweep with speeds from 30 to 200 frequency points per second. If a signal is detected above a threshold during the sweeping process, the receiver can be programmed to stop on that signal for further evaluation. It is then up to the radio operator to manually determine if this newly captured signal is of interest or not. If not, then the radio operator allows the receiver to continue sweeping. Such a traditional setup is suitable for the detection of relatively long duration communications such as voice or a low speed data links.

This simple system has several drawbacks including the fact that sudden, short duration signals are extremely unlikely to be captured. In addition, even if a short-duration signal is captured, it is impossible for the radio operator to manually discern any information from it in such a short period of time.

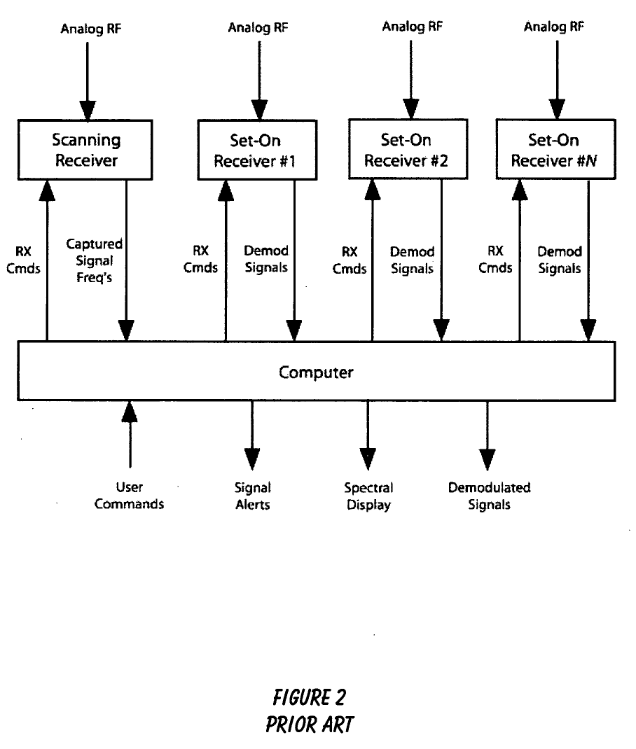

The prior-art of FIG. 2 is a more elaborate present-day signal capture system. This typical system uses a fast scanning receiver which captures signals that again exceed a threshold strength and duration. Then the frequency of that signal is handed-off to a set-on receiver. The advantage is that the set-on receiver has wider filters that allow more signal bandwidth information to pass to the demodulation stage. In addition, as multiple signals appear, they can be handed off one by one to a pool of set-on receivers.

But again, this prior-art system has many of the same drawbacks as the manual system of FIG. 1, including the fact that sudden, short duration signals are still very unlikely to be captured. For example, just like the system of FIG. 1, the system of FIG. 2 cannot handle frequency hopping signals.

The invention disclosed herein is a combination of hardware and specialized software. The invention is a device that has at least 3 input/output ports. One port (data input) takes in the analog IF output of a standard frequency converter device (such as a down-converter, up-converter, or a receiver). Another port (converter control port) is used to control the converter itself through the appropriate connection. The third port (user interface) is used to connect the invention to a workstation or computer for displaying the outputs and various spectrums.

The invention processes the entire IF output of a converter at once. Thus all the signal information contained within the bandwidth of the IF filter can be analyzed instantly. The resulting IF output may contain one or many short duration communication signals. All of these signals can be detected, captured, and even demodulated automatically. An evaluation on whether or not a signal is new is performed automatically by the invention's specialized software algorithms (described later).

Once complete, the invention outputs the results through a computer interface to a workstation or computer for proper user presentation. In addition, varieties of signal intelligence DSP algorithms can be installed (such as automatic demodulation algorithms, or signal alerts, or smart spectral displays) which would even further enhance the invention's use, creating alternate embodiments of this invention.

This invention is unique since no other device has the capability to automatically detect and/or automatically capture new and sudden short duration signals of interest.

Diagram Reference Numerals

10 Short duration RF signals

12 Converter device

13 Wideband Analog IF

14 Bandpass Filter

15 Filtered Analog IF

16 Wide band analog-to-digital (A/D) converter

18 Digital IF data

19 FIFO Buffer

20 Digital Tuner(s)

22 Hardware logic running DSP

24 Database memory of spectrum masks

26 Digitized IF that is up or down converted

28 Processed Spectrum (Digital IF data in the frequency domain)

30 Read spectrum mask (delivered to hardware logic 36 for evaluation)

32 Store spectrum mask (delivered to database memory 24 for storage)

34 FIFO Memory

36 Digital Filter

38 Filtered Spectrum Data

40 “New Signal” Detection Logic

42 Converter Commands

44 Tuner Commands

46 Read Signals from memory

48 Request Signals from memory

50 Invention

52 “New” signal alerts

54 User Interface Commands

56 Demodulated signals

58 Real-time spectrum displays

60 Computer running demodulation algorithms and display software

Operation

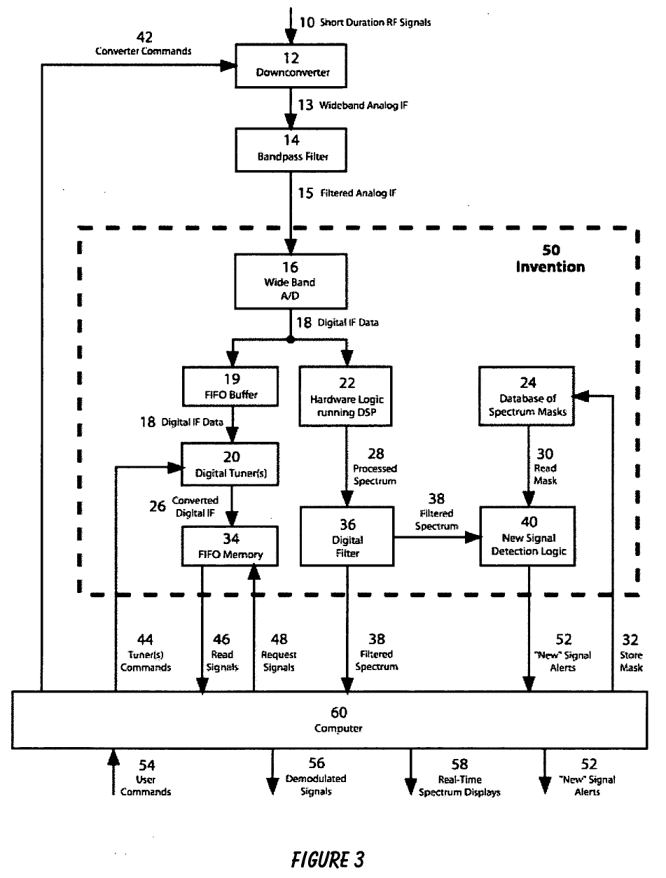

FIG. 3 is a functional depiction of a preferred embodiment of the system of the present invention. The invention instantaneously processes a wide bandwidth of RF spectrum and contains specialized software to process that data. This system WILL detect short duration signals such as frequency hopping signals and burst transmissions. Such suddenly appearing signals can be automatically detected and then automatically captured by this invention. In addition, the specialized software contains algorithms to intelligently perform processing ONLY on new signals, thus ignoring signals pre-designated as uninteresting. The combination between the automatic detection of sudden, short duration signals, and the intelligent gathering algorithms to automatically evaluate signals, is unique.

A converter device 12 (such as a receiver or a tuner) is tuned to a region of the RF spectrum where narrow band communications signals are anticipated. The converter 12 acts as an up-converter or down-converter device to properly shift the received spectrum into a usable IF range. The wide band analog IF output 13 is then fed through a bandpass filter 14 and then the filtered analog IF 15 is fed directly into the invention 50. Typically, the bandpass filters 14 are incorporated within output stages of the downconverters 12, thus it occurs in one hardware unit.

The invention 50 accepts the filtered analog IF 15 through an analog-to-digital (A/D) conversion component 16 for digitization. The digitized IF data 18 is then dually fed to a tuner (or set of tuners) 20 via FIFO buffer 19 for further frequency conversion, as well as to hardware logic 22 running several DSP algorithms (described below). Both pathways provide different features, as the reader will see.

It should be noted that the tuners 20 of the invention 50 could be controlled (re-tuned) by user commands 54 through the user interface computer 60, which then get sent by the computer 60 to the invention 50 as tuner commands 44 and eventually to the tuner(s) 20. Furthermore, user commands 54 can command the external converter 12 to re-tune to a different portion of the RF spectrum. The user interface computer 60 also forwards these converter commands 42. This capability will allow the user to interface with the system and selectively monitor any portion of the RF spectrum.

Returning to the discussion of the signal flow: The first pathway is through hardware logic 22 (such as an FPGA device) which performs various DSP algorithms. The first algorithm involves a fast Fourier transformation (FFT) to transform the digitized IF 18 from the time domain to the frequency domain. The FFT can be of 1024 points or higher. The output of the FFT is digital I and Q data. The I/Q data then goes through another algorithm that anti-aliases them. Finally, the I and Q data is combined by a summing algorithm which takes the square values of I and Q, sums them, and then square roots the sum. The result is the normalized amplitude of the I/Q, which is the processed spectrum 28.

The processed spectrum 28 is then fed to hardware logic 36 (such as an FPGA, or a programmed CPU) that performs digital filtering (averaging) of the resulting frequency bins. The filtered spectrum data 38 is then output to the computer 60. The computer 60 takes the spectrums and stores these baseline spectrums (or “masks”) into database 24 through store mask operation 32. Database 24 is then accessed by “new signal” detection logic 40 continually (through read mask operations 30) in order to determine if incoming spectrums 38 contain new signals when compared to the masks (previously observed or operator provided spectrums) that are stored in database 24.

Thus, the first step in using the invention 50 is for a radio operator to survey the RF environment for the purposes of identifying which recurring signals are of non-importance. By taking a snapshot of the received RF environment a mask is originally generated (simply the present filtered spectrum 38). The radio operator, through the user interface of computer 60, then evaluates this mask and determines if all the signals present are uninteresting, yet recurring signals. The operator can also optionally insert additional known frequencies to the spectrum mask. Once complete, the radio operator then stores (32) this database mask into the database memory 24.

Then the radio operator begins monitoring the RF spectrum by tuning the front-end converter 12 and streaming the analog IF data into the invention 50. The spectrums 38 are taken and continually compared to the mask that is read (30) out from the database memory 24. New signal detection logic 40 performs a point-by-point comparison of the mask with the newly arrived filtered spectrum 38 with varieties of configurable thresholds. After this comparison is performed by new signal detection logic 40, any signals present in the newly arrived spectrum 38 that deviated from the mask are immediately determined to be new, and further processed. Processing involves new signal alerts 52 which are immediately sent to the computer 60. This provides for automatic short duration signal detection.

If the reader recalls, the second pathway involves the digitized IF data 18 to be fed to tuner(s) 20 through the FIFO buffer 19. The tuners then output a digitally down-converted IF signal 26 that is subsequently fed to a FIFO memory 34 for temporary storage. All signal data is constantly sent to the FIFO buffer 19. This is done so that the resulting digital data can be further processed (demodulated, decoded, and stored), while the system simultaneously receives new incoming data.

The computer 60 has to perform other user interface tasks and because of that, the buffer is needed for practical purposes. The computer 60 sends a request 48 to the FIFO buffer 34 for the converted digital IF data 26 as quickly as it can, using a direct memory access (DMA) transfer. Because of the FIFO buffer 19, the read signals 46 represent the entire length of the short duration signal, and thus, no data is lost.

It should be noted that this invention 50 could also output the real-time spectrum display 58. Such a display will be able to show the presence of short duration RF signals 10 as they are automatically detected and captured by this system.

A very unique feature of invention 50 involves a specialized software routine running on new signal detection logic 40 that would automatically be activated upon detection of a short duration signal 10. The new signal detection logic 40 would then send a command directly to the computer 60 which would in turn send a tuner command 44 to the digital tuners 20 to go to that frequency (or center on a range of frequencies) so that a higher resolution FFT can be performed on such signals. This is because the tuners are now focused on a much smaller frequency span. Thus, it provides an “automatic resolution focusing” of the signal. This is unique in that as short duration signals appear, and are recognized by the invention 50, there is now a mechanism to obtain much high-resolution recordings of those signals, automatically. This process cannot be done manually as the short duration signals are too fast for prior art systems to react.

An alternate embodiment of the invention 50 involves the automatic demodulation of the short duration signals taken from the FIFO memory 34. The new signal alerts 52 triggers a separate mechanism within computer 60. At that point, the data is sent to a software FFT and modulation recognition program within computer 60. This modulation recognition program is fully automated. It starts by taking a known demodulation sequence and applying it to the signal data taken from the buffer 34. The program reviews the output, and through a series of threshold settings, determines if the demodulation algorithm applied was the correct one. If not, then the program loads a new demodulation algorithm and continues this process until a match is determined.

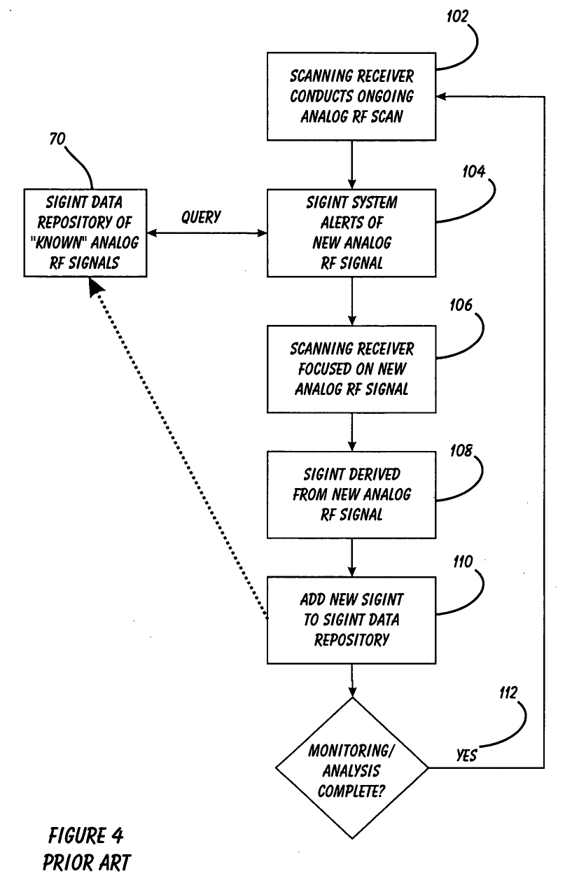

FIG. 4 is a flow chart of the method employed by the prior art system of FIG. 1. The scanning receiver conducts an ongoing scan of analog RF transmission intercepts 102. When, upon comparing with a data repository of “known” analog RF signals 70, the system alerts the operator of a new analog RF signal 104, the operator and/or the system focuses the scanning receiver on the new RF signal 106 (i.e. a suspected signal of interest). The receiver remains focused on the analog RF of the signal of interest for a time adequate to derive the SIGINT from that signal 108, after which, the operator/system adds the new signal intelligence 110 to the SIGINT data repository 70. When the monitoring and/or analysis is complete 112, the scanning receiver is returned to scan mode.

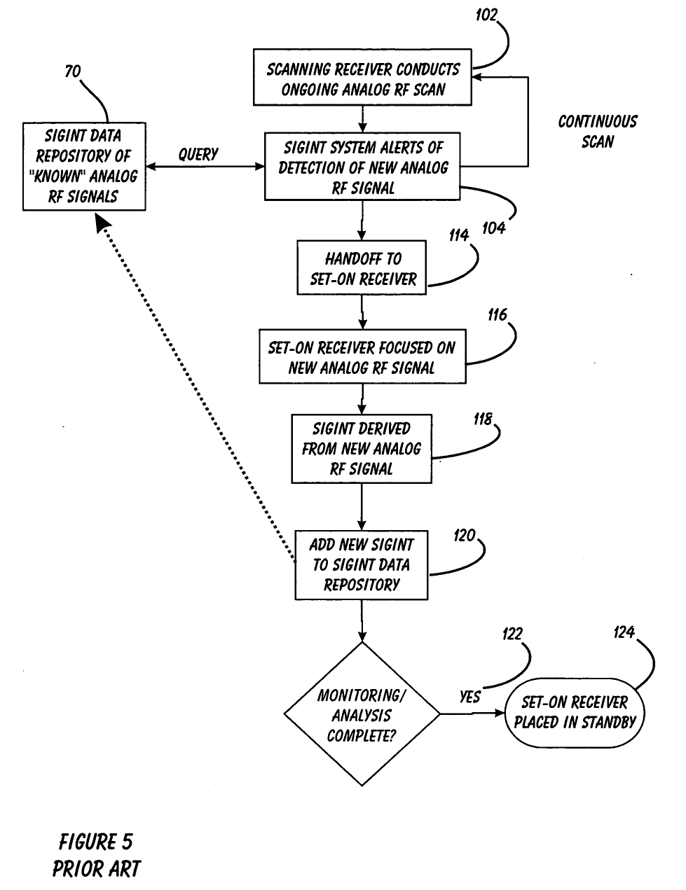

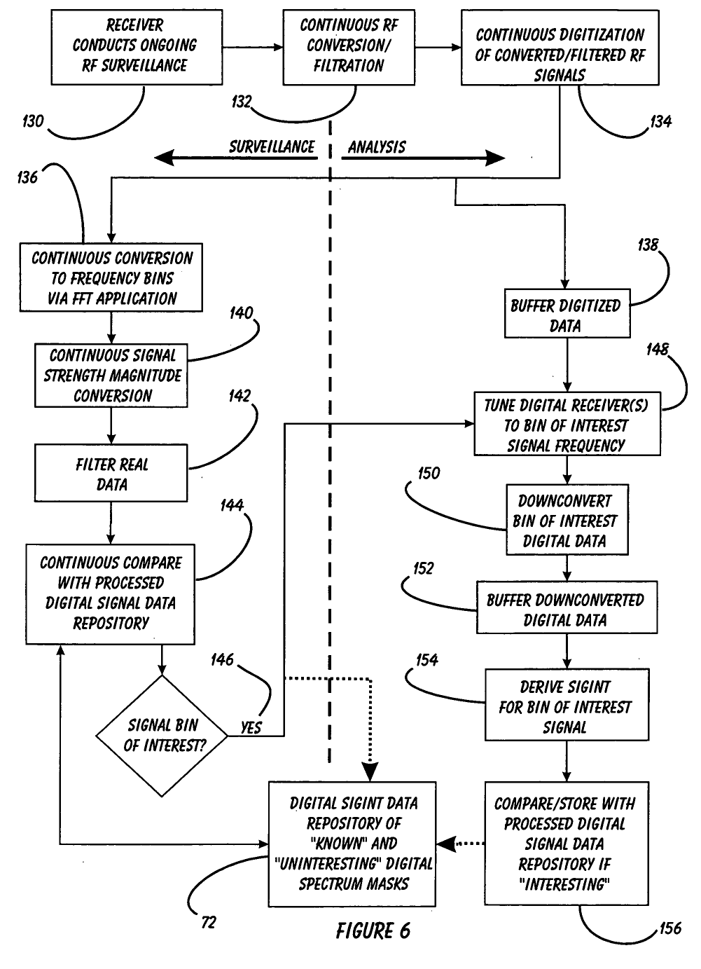

FIG. 5 is a flow chart of the method employed by the prior art system of FIG. 2. The scanning receiver again conducts an ongoing analog RF scan 102, until such time as the SIGINT system alerts the operator/system that a new signal has been detected 104. At this point, the handoff occurs to set-on receiver 114. The set-on receiver is then focused on the frequency band of the new RF signal 116. The set-on receiver remains on the new signal's frequency 116 until the SIGINT is derived 118, at which time the SIGINT data for that new signal is added to the repository 70. In this system, when the monitoring/analysis is completed 122, the set-on receiver is placed in standby 124 awaiting another signal of interest to be discovered by the scanning receiver. Having reviewed the prior methods, we can now contrast the method employed by the system of the present invention, as depicted in FIG. 6.

Rather than utilizing a scanning analog RF receiver, the system of the present invention uses a “surveillance” analog receiver, also perhaps called a converter. The surveillance receiver does not scan a narrow band of frequency, but instead simply “listens” to for any emissions on virtually any RF frequency, and very significantly, at very low detection levels. The received/detected analog RF is continuously converted and filtered 132, and then converted into digital data 134. The digitized data then passes to two branches on a continuous basis—the surveillance branch and the analysis branch of the method. Absent further action, the digitized data continuously updates a memory buffer 138 for later analytical use.

The digitized data passing to the surveillance branch is continuously split into narrow bands or bins of frequency 136 through application of an FFT. Next, the signal strength of each frequency bins is maximized by summing all of the components of any signals detected in each bin 140—this preserves the real signal data in order to accentuate the amplitude of any bins containing signals.

The summed or real data is then filtered 142 after which it is continuously compared to a data repository containing spectrum masks of known signals 72. If a frequency bin contains a detected signal of interest 146, then one or more digital receivers are tuned to the frequency represented by that bin 148. Since the digital receivers are actually receiving buffered digital data, these digital receivers can actually tune to the bin of interest frequency before the data of interest “arrives” at the digital receivers. The digital data from the tuned digital receiver(s) is downconverted 150 and then buffered 152 again so that the SIGINT can be derived from the signal 154. The signal and its derived SIGINT is then, optionally, compared and/or stored 156 with the digital data repository of spectrum masks. Unlike the prior systems, the new method will not only detect more signals (and particularly short-duration signals), but it will also allow the operator to conduct in-depth analysis of virtually any detected signal, no matter its duration.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A signal intelligence system, comprising:
a surveillance receiver for receiving RF signals across a broad spectrum;
a digitizer for creating a continuous stream of digitized data representing said received RF signals;
digital data conversion means for converting said digitized data into frequency bins;
comparing means for comparing each said bin to data stored in a data repository;
buffer means for buffering said digitized data;
digital receiver means for receiving a narrow band of said buffered digitized data; and
trigger means responsive to said comparing, for triggering said digital receiver means to tune to a frequency of interest.

2. The system of claim 1, wherein said digital data conversion means comprises means for converting said digitized data from a time domain to a frequency domain.

3. The system of claim 2, wherein said digital data conversion means comprises means for converting said frequency domain converted data from separate real and imaginary components to normalized amplitude data.

4. The system of claim 3, wherein said normalized amplitude data is categorized by frequency bins.

5. The system of claim 4, wherein said comparing means comprises comparing data in said frequency bins to frequency masks stored in said data repository.

6. The system of claim 5, further comprising second buffer means for buffering data received by said digital receiver means.

7. The system of claim 6, wherein said trigger means is responsive to a received said frequency bin being previously absent from said data repository.

8. A method for analyzing RF signal transmissions comprising the steps of:
detecting an analog RF signal transmission;
digitizing said detected RF signal;
buffering said digitized signal;
converting said digitized signal into frequency bins;
comparing said frequency bins to known frequency bin data; and
triggering a digital receiver to receive said buffered data, said triggering responsive to said comparing.

9. The method of claim 8, wherein said triggering step comprises tuning a digital receiver to a frequency in close proximity to a frequency represented by a said compared frequency bin.

10. The method of claim 9, further comprising a second buffering step, said second buffering step comprising buffering data received by said digital receiver.

11. A method for analyzing RF signal transmissions comprising the steps of:
detecting an analog RF signal transmission;
digitizing said detected RF signal;
buffering said digitized signal;
converting said digitized signal into frequency bins, said buffering and said converting being continuous and simultaneous;
comparing said frequency bins to known frequency bin data; and
triggering a digital receiver to receive said buffered data, said triggering responsive to said comparing.

12. The method of claim 11, further comprising a second buffering step, said second buffering step comprising buffering data received by said digital receiver.

13. The method of claim 12, wherein said triggering step comprises tuning a digital receiver to a frequency in close proximity to a frequency represented by a said compared frequency bin.
